(19) United States
(12) Patent Application Publication
(10) Pub. No.: US 2015/0231554 A1
(43) Pub. Date: Aug. 20, 2015

(54) GAS PURIFICATION METHOD

(71) Applicant: Rafik Nailovich Khamidullin, Kazan (RU)

(72) Inventor: Rafik Nailovich Khamidullin, Kazan (RU)

(21) Appl. No.: 14/406,986

(22) PCT Filed: Jun. 5, 2013
(86) PCT No.: PCT/RU2013/000459

§ 371 Date: May 1, 2015

(30) Foreign Application Priority Data
Jun. 15, 2012 (RU) 2012124943

(51) Int. Cl. B01D 53/14; B01D 53/00; B01D 53/26

(52) U.S. Cl. CPC B01D 53/14; B01D 53/265; B01D 53/002; B01D 53/1406

(57) ABSTRACT

Methods for conducting heat-mass-exchange processes for a gas-liquid system, inter alia for conditioning and drying air, and for purifying gases of impurities of other gases, vapors of liquid and dispersed solid particles. In the purification of gases, including the cooling of a gas flow, the formation and extraction of a condensate, along with absorbed gaseous and mechanical impurities, to be used as a cold heat-carrier coming into direct contact with the gas flow, the previously-formed condensate of the gas flow to be cleaned is used, after being cooled to a temperature lower than the dew point of said gas flow. Prior to the interaction of the gas to be separated and the cooled condensate, a portion of the previously produced condensate, uncooled, is introduced to saturate the gaseous phase with vapor, resulting in an increased amount of condensate on the liquid or solid particles, thus increasing separation efficiency.

The invention is intended for heat-mass-exchange processes for gas-liquid system, inter alia for air conditioning and drying, gas purification of impurities of other gases, liquid vapor and dispersed solid particles. The invention can be employed in air conditioning systems, in the sanitary purification of gaseous emissions, and in preparing natural or associated petroleum gases prior to the use or transport thereof (drying, removal of higher hydrocarbons, hydrogen sulphide, carbon dioxide, etc.). The invention finds an application in oil and gas processing, heat-power engineering, metallurgy industry, chemical industry, construction industry, and in other branches of industry.

The known petroleum gas dehydration method consists in that cooled gas flow is fed to 70-80% aqueous solution of ethylene glycol (as a hydrate inhibitor) (The drying gas unit operation analysis at the West Siberian gas processing plant. Pluzhnikov G. S. The petroleum gas purification and drying, and equipment corrosion protection. (Collection of scientific papers). Moscow, VNIIOENG, 1984.). The most of water vapor is condensed upon gas cooling, as a result content of water vapor in gas decreases repeatedly (in 30-200 times depending on the cooling temperature). Water solution is fed in finely-divided state directly onto the tube sheet of heat exchanger and propane refrigerators into the tube side.

The disadvantage of this method is a complexity of process implementation, low degree of drying and cooling of the gas due to the low efficiency of heat exchange because of the thermal resistance of glycol solution film with condensation and solid separating wall of heat exchanger.

The known method of gas purification from gas condensate consists of liquid absorption in the form of its own gas condensate, eddy of the gas flow in a vortex tube with simultaneous absorbent condensation therein, purified gas disposal and condensation. Absorption is carried out at low pressure, enriched gas flow by own gas condensate is divided in two streams, one of which is swirled in a vortex tube with simultaneous overcooling, purification and disposal of purified gas. Wherein another gas stream is cooled and separated, and the separated gas stream is fed into the general purified gas stream (RU N^{o} 2179880 patent description “Gas purification method and device for its implementation. Malyshev A. I.; Mokshin V. I.; Malyshev E. A., etc., CJSC “LUKOIL-PERM” Feb. 27, 2002).

Disadvantage of this method is the need for high energy costs for generation of a high pressure differential, speed for realization of this process. The condensation of separated components from a gas stream requires certain conditions (supersaturation, presence of condensation centers, etc.) which reduce the gas purification efficiency and increase process time.

Method of gas treatment is the closest to the proposed gas purification method (prior art). (Specification of author's certificate No 352094 Sep. 21, 1972, Bull. No 28. N. V. Tsarenko, V. M. Minakovsky, V. A. Antonenko. Gas treatment method). The method consists in gas treatment by cooling and drying while passing through the pseudoliquified layer of solid particles, which is wettable by liquid, liquid vapors are removed from the gas, wherein the temperature of the solid particles is maintained below the freezing temperature of the liquid.

Disadvantage of the prior art is complexity of the process, its automation and control, the presence of an intermediate coolant in the form of solids that generates some difficulties with its cooling, dosing, and disposal.

The objective of the present invention is to provide a simple, effective and reliable gas purification method of the gaseous, liquid and solid impurities, reducing of equipment material consumption and operational costs.

The assigned task is reached by the fact that in gas purification process, comprising cooling of the gas stream, the formation of condensate, its separation by the absorbed gaseous and mechanical impurities as a cold heat transfer fluid, is used previously formed condensate from gas flow to be purified, which is cooled to a temperature below the dew point of the gas flow. Before the interaction of gas for separation and the cooled condensate, part of the previously obtained condensate is added without its cooling in order to saturate the gas phase by vapor and the subsequent increase amount of condensate on a liquid or solid particles to improve their separation efficiency. Various components are added to the condensate used as heat transfer fluid, to impart certain physico-chemical properties. In order to separate an individual component or group of components of the gas phase on each stage gas purification is carried out in several stages.

The method is implemented as follows.

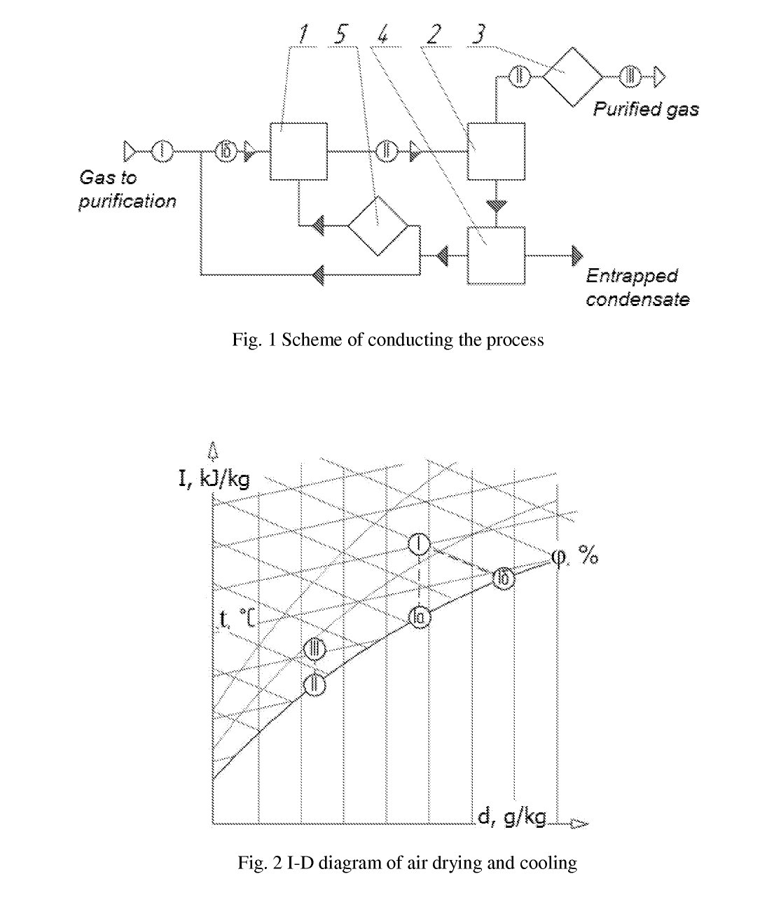

Gas to be purified and cooled condensate are fed into a mixer 1 (see FIG. 1), where the heat and mass transfer occur between the streams. As a result of this interaction, the gas to be purified is cooled down to supersaturation conditions of gas components, and gaseous impurities condense on the cold surface of the condensate. Further the gas flow is separated from the dropping liquid in a separator 2, if necessary gas flow is heated in heater 3 (for example, to initial temperature), and it's in a purified form directed further for its destination.

The liquid mixture of initial condensate, condenced vapor and absorbed gas impurities is separated from gas flow in a separator 2, flows into reservoir 4, is cooled in a refregerator 4 (by external cooling source), and further flows at the beginning of the process again to the interaction with the gas flow. Excess condensate is removed from the tank 4 and directed further for its destination, or for processing and disposal. The process of gas purification and condensate separation is continuous in closed cycle.

In the interaction process with the gas flow, condensate acts as a condensation center of trapped vapor impurities, which helps to speed up the process by reducing the formation time of condensation centers.

Condensate is an absorbent for the physical absorption of other gas impurities that allows to extract components from gas flow to be purified, wherein dew point (or condensation temperature) of components is significantly lower than the process temperature. According to Henry's Law, this process is accelerated by the reduction of the distribution coefficient at low temperature, which describes the content of adsorbed component in a liquid with its equilibrium concentration in the gas, increasing the amount of adsorbed component in the liquid, and as a result, the degree of its extraction from a gas phase.

This process also allows to trap solid impurities in the gas flow. Solid impurities depose on a liquid surface during the interaction of liquid condensate with gas flow to be purified due to inertial forces of particles and turbulent diffusion. Process of purification from solid impurities is accelerated by the condensation process, in which dust particles are also condensation centers for the entrapped vapor. Moreover, during the interaction after entrapping of solid particulates, the surface of the initial liquid is well renewed by condensed vapor that promotes intensification of the gas purification process of solid particles. In gas purification from solid particles liquid with trapped solid impurities is also separated from solids during separation from gas flow.

To increase the amount of vapor (if it is possible under given conditions), which is condensed in the gas to be purified and cooled condensate interaction process, part of the previously selected condensate is directed to mixing with the gas flow prior to cooling. Increasing the amount of vapor in the gas increases the amount of condensation on the solid and liquid impurities' surfaces in the cooling process (at constant amount of rejected heat), which allows more effective separation of trapped particles due to their greater inertia.

If the physico-chemical properties of the liquid phase don't allow effective interaction with the gas phase under the process conditions (high values of viscosity, corrosion activity, change the phase state of impurities, separation of the solid phase, etc.), various components are added to the condensate, providing necessary properties.

In order to separate the resulting condensate into its component parts, gas purification process is carried out in several stages. The process conditions may vary in stages by the temperatire and pressure, depending from condensate formation conditions of components of gas flow to be purified. At every stage condensate separated and used over again for the interaction with the gas flow, has a specific composition corresponding to the process conditions.

The implementation of the claimed method is explained by gas purification scheme shown in FIG. 1.

The implementation example of the method is presented by the process of water vapor separation from the air (drying and cooling of moist air).

Initial conditions: air entering temperature 35° C., humidity 40%, moisture content 13.89 g/kg, the dew point temperature 19.35° C. The air exit temperature 17° C., humidity 80%, moisture content 9.52 g/kg. The air consumption 500 kg/hr (435 m³/h), supplied condensate temperature 8.52° C. Heat loss is neglected, the efficiency of interaction between the gas and the liquid is taken 100%.

Graphic illustration of an example is shown in I-d Ramzin diagram, FIG. 2, initial, intermediate and final state parameters of moist air of the considered process are shown in Table.

The interaction of air with cooled condensate (water) is carried out according to the scheme I-Ia-II-III. Initial conditions correspond to point I. At initial conditions air flows to the mixer 1 (FIG. 1), where it interacts with cooled condensate. The conditions after this interaction correspond to point II. Intermediate state interaction of air and the cooled condensate in the mixer, whereby the air is cooled to the dew point temperature, corresponds to the point Ia (not shown on the scheme). Since the condensate temperature is lower than the dew point, the transition of the condensate to the gas phase generally excluded, therefore in this reaction only cooling of the gas flow to a dew point occurs, and thereafter air is cooled simultaneously with the water vapor condensation. Further, when needed parameters for moisture content are achieved (point II), the flow is separated from the liquid phase, if necessary, heated (point III), and further transported to its destination.

Table of moist air drying and cooling process parameters.

| | | Number and name of point | | | | |
|---|---|---|---|---|---|---|
| | | | Ia. Air cooling | | | |
| | | | by cooled | Ib. Air cooling | II. Air cooling | |
| | | I. Initial | condensate to dew | by water to wet | and drying on the | III. Air |
| No | Parameter | state | point temperature | bulb temperature | saturation line | heating |
| 1 | Dry bulb temperature, ° C. | 35 | 19.35 | 23.85 | 13.52 | 17 |
| 2 | Relative humidity, % | 40 | 100 | 100 | 100 | 80 |
| 3 | Enthalpy, kJ/kg | 70.82 | 54.68 | 70.83 | 37.63 | 41.19 |
| 4 | Moisture content, g/kg | 13.89 | 13.89 | 18.41 | 9.52 | 9.52 |
| 5 | Wet bulb temperature, ° C. | 23.89 | 23.85 | 23.85 | 13.52 | 14.89 |
| 6 | Dew point temperature, ° C. | 19.35 | 19.35 | 23.85 | 13.52 | 13.52 |
| 7 | Water vapor partial | 16.6 | 16.6 | 21.85 | 11.45 | 11.45 |
| | pressure, mmHg | | | | | |

In case of previously obtained condensate is fed without cooling prior to interaction of the gas to be separated and the cooled condensate the process follows the scheme I-Ib-II-III, FIG. 2. Point Ib corresponds to wet bulb temperature for the conditions of point I. In this variant of interaction the air is cooled to a temperature of wet bulb by water evaporation, while water vapor proportion in the air increases (see Table, point Ib), and hereinafter the amount of condensed water vapor on the liquid and solid impurities also increases that simplifies their subsequent separation. The amount of rejected heat from the gas phase of the present embodiment is similar to amount of heat according to an embodiment of the air and cooled condensate interaction, Scheme I-Ia-II-III.

In the considered example, as in the proposed method, depending on heat and material balance of individual liquid and gas interaction sites, as well as the proportion of the uncooled condensate directed to evaporation, no matter of the interaction scheme, the intermediate points Ia and Ib position (FIG. 2) may be at any other location, limited by vertices of the triangle with points I-Ia-Ib. However, with an increase of energy rejection from the gas stream, over the difference in enthalpy values of points I and Ia, the process will go on line Ia-II, and then the process will go identically in all cases along the saturation line.

In considered example with the air consumption of 500 kg/h, the heat consumption rejected from the air will be 4.61 kW, including 0.49 kW that is back to the air heating (from point II to point III). Water consumption will be 0.794 m³/h (including 2.185 l/h of recovered condensate), the change in its temperature during the interaction with air will be 5° C. (from 8.52 to 13.52—dew point temperature of the air in output). If necessary, at the end of the purification process the air temperature (point III) can be raised to initial point (point I).

The advantages of this invention are simplification of the gas purification process, reduction of energy consumption and metal consumption of process implementation.

In this purification method a further effective gas purification from the solids is possible that allows a complex gas purification from various impurities.

The proposed method allows to accurately maintain and automate the purification process parameters (extracted amount of vapor, disperse and absorbed gaseous impurities) by the temperature regulation and amount of feed condensate.

This method allows to avoid the significant pressure loss of the gas flow to carry out the purification process by reducing the gas temperature by external cooling source, in contrast to the gas cooling by its throttling.

The proposed technical solution is titled by applicant as process of “Gas purification by cooled condensate.”

1. A gas purification method, comprising gas flow cooling, condensate formation and its separation with absorbed gas and mechanical impurities, wherein the previously formed condensate from the gas flow to be purified and cooled to a temperature below the dew point of the gas flow is used as the cold coolant, which in direct contact with the gas flow.

2. The method according to claim 1, wherein before the gas to be separated and cooled condensate interaction the part of the previously obtained condensate is fed without cooling in order to saturate the gas phase by vapor and the further to increase amount of condensate liquid and solid particles to increase their separation efficiency.

3. The method according to claim 1, wherein various components are added to the condensate, which is used as a coolant, to impart certain physical and chemical properties.

4. The method according to claim 1, wherein the gas purification process is carried out in stages, in order to separate an individual component or group of components of the gas phase at each stage.

5. A gas purification method, comprising:
mixing a first volume of gas to be purified and a cooled condensate;
cooling the first volume of gas to condense impurities from the first volume of gas onto the condensate;
separating the first volume of gas from the condensate with condensed impurities; and
mixing a second volume of gas to be purified with the condensate with condensed impurities.

6. The method of claim 4, wherein a dew point of the impurities is lower than a process temperature.
